(19) United States
(12) Patent Application Publication
(10) Pub. No.: US 2026/0236538 A1
(43) Pub. Date: Aug. 13, 2026

(54) Continuous and Automated Digital Information Classification

(71) Applicant: Saudi Arabian Oil Company, Dhahran (SA)

(72) Inventors: Bashar Altakrouri, Dhahran (SA); Kais Barakat, Dhahran (SA)

(21) Appl. No.: 19/050,468

(22) Filed: Feb. 11, 2025

(51) Int. Cl. G06F 16/906; G06F 40/279; G06F 40/30

(52) U.S. Cl. CPC G06F 16/906; G06F 40/279; G06F 40/30

(57) ABSTRACT

A computer implemented method that enables continuous and automated digital information classification is described. The method includes monitoring digital information creation, modification and viewing. Keywords and intents are extracted from the content of the digital information. Contexts associated with the digital information are determined, and the digital information is iteratively classified in response to creation, modification and viewing based on the extracted keywords, intents, and contexts.

### TECHNICAL FIELD

This disclosure relates generally to cybersecurity and data protection, and more particularly, to continuous and automated digital information classification.

### BACKGROUND

Organizations classify documents to manage and protect information. Protecting information from unauthorized access enables compliance with regulations and ensures operational continuity.

### BRIEF DESCRIPTION OF DRAWINGS

FIG. 1 shows elements of an organization.

FIG. 2 shows a workflow that enables automatic, dynamic, and continuous information document classification and data leakage prevention based on natural language understanding and context sensing.

FIG. 3 shows an implementation of automatic, dynamic and continuous information document classification based changing intent and context change.

FIG. 4 is a process flow diagram of a process that enables continuous and automated digital information classification.

FIG. 5 illustrates hydrocarbon production operations that include both one or more field operations and one or more computational operations, which exchange information and control exploration for the production of hydrocarbons.

FIG. 6 is a schematic illustration of an example controller (or control system) for that enables a continuous and automated digital information classification.

### DETAILED DESCRIPTION

An organization implements various policies and procedures to ensure data integrity, security, and accessibility associated with digital information. Digital information includes, for example, text documents, word processing documents, portable document files (PDFs), spreadsheets, presentations, images, videos, and the like. Digital information may be, for example, associated with an organization's infrastructure, such as oil and gas plants, power plants, water treatment facilities, and the like. Further, digital information can describe processes or procedures associated with an organization. Classification of digital information can in compliance efforts that ensures an organization adheres to laws, regulations, standards, or organizational internal policies. Classification of digital information highlights the sensitivity and criticality of the information to ensure it is secured properly against security breaches. For example, by identifying and protecting sensitive data, organizations can mitigate the risks of unauthorized access and potential breaches, avoiding the negative consequences of compromised security.

Embodiments described herein enable continuous and automated digital information classification. The digital information enables the implementation of functions of the organization. For example, an oil and gas organization can have digital information that include details about an oil and gas plant infrastructure, such as engineering and design documents, operation manuals, safety reports, environmental impact assessments, maintenance logs, and the like. Additionally, an oil and gas organization can have digital information such as financial records, employee records, contracts, agreements, and strategic planning documents. The present techniques automatically and continuously classify the digital information. For ease of description, the digital information is referred to as a document. However, any type of digital information can be automatically and continuously classified according to the present techniques.

In examples, a document is classified over the entire lifecycle of document from creation, modification, dissemination (i.e., viewing), up to destruction. The document is classified based on the content of the document and context information. Data extracted from the document is used to determine origins of the content of the document. The extracted data includes, for example, keywords (e.g., words used to classify or organize digital information) and intent. Contexts associated with the digital information include context associated with the document, context associated with the at least one user, context associated with the physical environment, context associated with the virtual environment, or any combinations thereof. The document is iteratively classified when the document is created, modified, or viewed. For example, the document is modified in accordance with the data generated at a user device when a user changes document content. The origin of the content and contexts are determined when the document is created, modified, or viewed, and are used to determine a classification of the document, in real time.

Some advantages of the present techniques include an improvement to document classification that accurately and efficiently assigns a classification to a document as interactions (e.g., creation, editing, viewing, destruction, etc.) occur, in real time. The continuous and automated information classification described herein exceeds human capabilities. Traditional techniques that classify documents jeopardize either the information protection or the user experience. For example, manual classification relies on the expertise of a user to classify the document which takes time and creates an extra load of the user's interaction expertise with the document.

Users can be prone to mistakes that result in misclassified documents, such as overlooking details relevant to the classification of documents. In some cases, a user can intentionally or maliciously misclassify documents. Traditional automatic classification purely based on the document content may tend to over classify documents (increased classification level beyond the actual classification level of the document), causing unintended restrictions on the user interactions with the document (e.g., blocking sharing of a General Use document because it is misclassified as Confidential).

The present techniques improve the functioning of a computer by enabling accurate classification based on a multifaceted context. The present techniques are a particular solution to document classification based on keywords, intent, and contexts of the document as it is created, modified, or viewed to determine an accurate classification. In this manner, the classification as described herein ensures the proper security of the digital information of an organization, where a security breach could lead to dangerous situations that negatively impact the organization and potentially cause physical harm to workers or the public. The classifications ensure operational continuity of industrial systems where a breach due to improper data classification could disrupt these systems, leading to significant downtime, production losses, and financial impact. Further, protecting digital information from unauthorized access according to the classification enables an organization to maintain competitive advantage and comply with regulations.

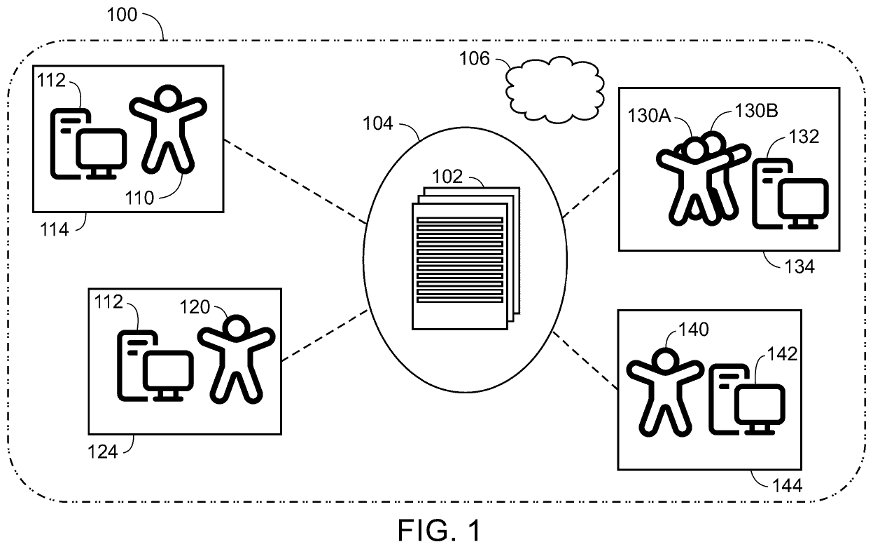

FIG. 1 shows elements of an organization 100. As shown in the example of FIG. 1 the organization 100 includes users 110, 120, 130A, 130B, and 140 associated with the organization. In examples, users 110, 120, 130A, 130B, and 140 are associated with the organization 100 and can access resources of the organization, such as digital information 102 stored on server 104. The digital information 102 includes text documents, word processing documents, portable document files (PDFs), spreadsheets, presentations, image files, and the like.

In examples, the organization 100 functions to achieve a goal or objective. For example, the organization 100 is an oil and gas organization that performs hydrocarbon exploration, planning, and drilling. An oil and gas organization functions to maximize production efficiency by ensuring that oil and gas extraction processes are as efficient and cost-effective as possible. Other goals or objectives of an oil and gas organization include, for example: ensuring safety and environmental compliance by adhering to safety standards and environmental regulations to minimize risks and environmental impact; optimizing financial performance by managing costs and maximizing profitability through efficient operations and strategic investments; and promoting sustainability and decarbonization by reducing carbon footprints and investing in sustainable practices.

Users 110, 120, 130A, 130B, and 140 associated with the organization 100 include employees, contractors, consultants, volunteers, interns, board members, advisors, suppliers, and partners. Employees are individuals hired directly by the organization and are part of the organization's workforce. Contractors are individuals or companies hired to perform specific tasks or projects. Consultants are experts in specific areas, such as management, information technology (IT), or marketing, and are engaged by an organization for their specific expertise. Volunteers are individuals who offer their time and skills to the organization without monetary compensation.

Interns are students or recent graduates who work temporarily to gain practical experience in a field of study. Board members are individuals who serve on the organization's board of directors and providing governance and strategic direction.

Advisors are experts who provide guidance and recommendations on various aspects of the organization's operations or strategy. Suppliers are companies or individuals that provide goods and services necessary for the organization's operations. Partners are other organizations or entities that collaborate on projects, initiatives, or business ventures.

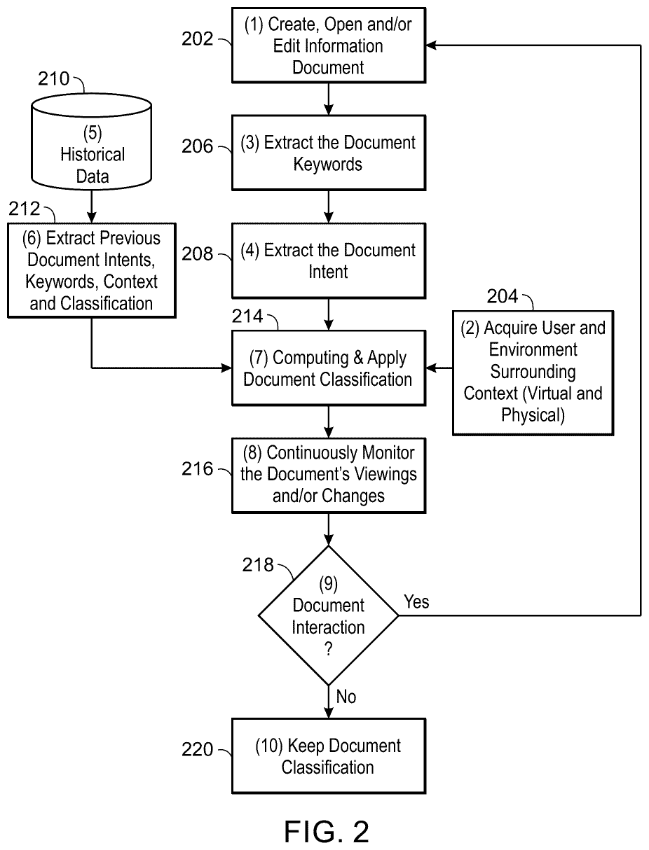

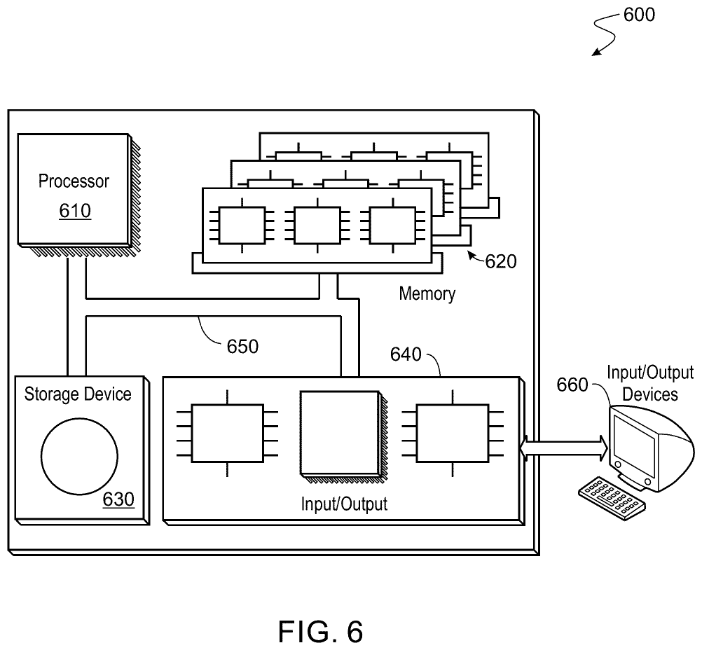

In the example of FIG. 1, user 110 accesses resources of the organization 102 using computer system 112 at location 114. User 120 accesses resources of the organization 102 using computer system 122 at location 124. Users 130A and 130B access resources of the organization 102 using computer system 132 at location 134. User 140 accesses resources of the organization 102 using computer system 142 at location 144. Resources of the organization include, for example, digital information 102. In examples, computer systems 112, 122, 132, and 142 are the same as or similar to computer system 600 of FIG. 6. Each respective user, computer system, and location are associated with various contexts as described with respect to block 204 of FIG. 2.

An organization 100 stores digital information 102 on the server 104, at a cloud location 106, or locally at computer systems 112, 122, 132, or 142. For ease of illustration, digital information 102 are shown as stored at the server 104. However, an organization can have any number of servers, clouds, or computing systems that store and organize documents. Once created, documents are stored and managed using document management systems (DMS) that provide version control, access permissions, and audit trails.

In examples, the digital information 102 are accessed, created, or updated by users 110, 120, 130A, 130B, and 140 of the organization 100. In examples, the digital information 102 includes strategic industry plans/operations, intelligence reports, technical specifications, research and development information, personnel files, financial records, legal documents, and the like. For example, strategic industry plans/operations include details about industry strategies, trends, and forecasts. Intelligence reports include information gathered by about industry competitors. Technical specifications include details about technology, field operation systems, or other infrastructure information. Research and development include information about ongoing or planned research projects. Personnel files include information about users associated with the organization, such as employees. Financial records include details about funding and expenditures related to objectives of the organization. Legal documents include legal opinions, court documents, or other legal materials associated with the organization.

The digital information 102 is assigned classifications within the organization 100 to ensure that the sensitivity of the information contained within the digital information 102 is matched with an appropriate level of protection. Classifications are assigned information that an organization deems as being sensitive, enabling an organization to eliminate information leakage of confidential information. Incorrect classification of information has negative implications that may lead to severe damage to the organization, due to leaking a confidential information due to miss classification (in the case of false negatives). Traditional classification tools are prone to false positives, where information is classified at a higher level of confidentiality than is needed. False positives reduce the usability and acceptance of the classification tools due to many false alarms (in the case of false positives), and can result in misutilization of the Data Leakage Prevention (DLP) resources due to low quality DLP events. The present techniques enable automatic and continuous classification of information based on artificial intelligence models that utilize natural language understanding and intent coupled with context-aware sensing (interactions with the document based on Internet of Things) during the information lifecycle. The accuracy of classifications is increased, and data leakage prevention efficiently deployed through accurate and real time digital information classification.

In examples, the classifications are based on a potential impact of the content contained within the digital information on interests of the organization. In some embodiments, the classifications include business use, public, company general use, confidential, and government confidential. In examples, business use refers to information used internally within the organization for business operations. This data is not intended for public release but may not be highly sensitive. In examples, public refers to information that is authorized for public release. Examples include marketing materials, press releases, and publicly available reports. In examples, company general use refers to internal information that is not sensitive but is intended for use by employees and possibly trusted partners. This might include internal newsletters, general policy documents, and non-sensitive operational data. In examples, confidential refers to sensitive information that should only be accessible to authorized personnel. This includes personal data, financial records, and proprietary business information. Unauthorized disclosure could cause harm to the organization. In examples, government confidential refers to information that is classified by government entities due to its potential impact on national security or public safety. This includes military plans, intelligence reports, and other sensitive government documents.

In some embodiments, the classifications include confidential, secret, and top secret. In examples, confidential refers to information that could cause some damage to the organization if disclosed. In examples, secret refers to information that could cause serious damage to the organization if disclosed. In examples, top secret refers to information that could cause exceptionally grave and detrimental damage to the organization if disclosed. For ease of description, finite levels of classifications are described. However, any number of classifications may be defined by an organization.

The varying levels of classifications enables an organization to implement risk management, resource allocation, and access control over digital information. For example, varying levels of classification enables risk management associated with an unauthorized disclosure. More sensitive information, such as top-secret information, is associated with stricter controls because its exposure could cause greater harm when compared with digital information associated with other levels of classification. Additionally, by classifying documents at varying levels, organizations can allocate security resources more efficiently. Highly classified documents are associated with more stringent security measures, which can be costly and resource intensive. Further, the varying levels of classifications can be used for legal and regulatory compliance. For example, some countries have laws and regulations that mandate the classification of certain types of information. Adhering to these requirements helps organizations avoid legal penalties and maintain compliance as appropriate based on rules and regulations.

In some embodiments, digital information 102 is automatically and continuously assigned classifications across the lifecycle of the respective information (e.g., from document creation to document destruction). Artificial intelligence and context-aware sensing are combined and used to continuously evaluate the digital information of an organization. In examples, artificial intelligence includes the use of natural language understanding and intent, and context-aware sensing includes monitoring and interpreting a multifaceted context, including interactions with the digital information based on Internet of Things.

Classification levels also enable determinations of who can access certain information. Within an organization, individuals assigned to particular roles can access digital information associated with particular classification levels. Those individuals with the appropriate clearance can access higher-level classified information, reducing the risk of leaks. The nature of the user, such as the user's employment status or relationship with the organization, determines an information access level of the user. In examples, a general employee is granted access to information classified as business use, public, or company general use; a general employee is denied access to information classified as confidential or government confidential. In examples, a senior employee is granted access to information classified as business use, public, company general use or confidential; a senior employee is denied access to information classified as government confidential. In examples, a volunteer is granted access to information classified as public; a volunteer is denied access to information classified as business use, company general use, confidential or government confidential. For ease of explanation, particular user roles are described as associated with access to particular classifications of digital information. However, the roles and access levels described are for exemplary purposes should not be viewed as limiting.

FIG. 2 shows a workflow that enables automatic, dynamic, and continuous information document classification and data leakage prevention based on natural language understanding and context sensing. In some embodiments, the workflow 200 is a local implementation that is server-based, where the local user device executes instructions that enable automatic, dynamic, and continuous digital information classification. In some embodiments, the workflow 200 is cloud-based (edge, private, or/and public) for an implementation where cloud-based servers and services enable the classification of digital information at a local user device.

At block 202, a document is either created, opened, processed (i.e., edited) by the user. In some embodiments, documents are generated at an electronic device, such as the computer system 600 of FIG. 6. For example, a user can create text documents, spreadsheets, presentations, and the like. Tools such as word processors, spreadsheet applications, and presentation software are used to create documents. Additionally, a user can upload other file formats, such as JPEGs or other images captured by cameras. The edited document, its classification and context data are stored on the user device or in any storage medium of choice by the user. In some embodiments, document creation is automated using software that creates documents based on templates and pre-defined rules. In a first iteration of the workflow 200, a document is created. Subsequent iterations of the workflow begin at block 202 when the document is opened for editing, viewed, or saved. In examples, the iterations are continuously triggered whenever new input from the user environment and surrounding context is obtained.

At block 204, context information is acquired. In some embodiments, respective context information is associated with respective classification levels. The physical context information includes, but is not limited to, a temporal context (e.g., time of interaction with document and a duration of the interaction), a social context (e.g., identity of surrounding people, private space, shared space, etc.) as interactions with the document occur, a nature of a user (e.g., the identity or role of a person interacting with the document), and a location context (e.g., location of a user). In examples, the social context is determined based on the interactions of the user with surrounding people during the creation, modification, or viewing of the document. The social context can be based on, for example, company related activities and information related to the company activities. The social context may be detected or acquired using local proximity sensing based on Internet of Things (IOT) technology or by a centralized localization sensing service. Local proximity sensing uses sensors and devices to detect the presence, location, and movement of objects or people within a specific area. A centralized localization sensing service detects people that work or appear in close proximity with each other. Other proximity sensing techniques include sensing devices in close proximity through their Bluetooth signals (signal strengths), WIFI signal strength, etc. In an example where digital information 102 is created, modified, or viewed at computing system 132 of FIG. 1, local proximity sensing is used to determine that multiple users 130A and 130B are at or substantially near the location 134 when digital information 102 is created, modified, or viewed.

Referring again to FIG. 2, at block 204, the nature of the user refers to a user's role and access level within the organization. In examples, access levels correspond to classifications of digital information, including public, internal use only, confidential, sensitive, restricted. In examples, a user's roles within the organizational hierarchy informs the access levels or classifications of digital information available to the user.

The virtual context includes the virtual settings or environment in which the document is created, modified, or viewed. In examples, the virtual context includes installed or executing applications and packages associated with the computing environment used to create, modify, or view the document. The virtual context can include operations performed on memory or storage devices, such as reads and writes. Moreover, the virtual context can include the creation, update, or destruction of data. The virtual context can further include data processing, such as manipulations and transformations executed by a processor.

At block 206, document keywords are extracted. Keywords are, for example, words or phrases that represent the main topics of the document. In some embodiments, keywords and tags that inform the classification are determined using a trained machine learning model. In examples, the keywords and tags are distinct words that correlate or indicate the classification of the document. These keywords are identified through either explicitly configured keyword lists/databases from the organization or keywords automatically extracted according to a machine learning model trained on historical documents. The machine learning model can use supervised learning or unsupervised learning to extract keywords. For example, supervised learning uses labeled training data to learn which words are likely to be keywords. Supervised learning algorithms for keyword extractions include KEA (Automatic Keyphrase Extraction). Unsupervised learning models find and learn from hidden patterns or intrinsic structures within the data. Unsupervised learning models include techniques such as KP-Miner, TextRank, RAKE and Latent Dirichlet Allocation (LDA).

At block 208, the document intent is extracted using natural language processing techniques. Intent refers to an intended meaning or purpose of a sentence, statement, image, or other information contained in a document. In some embodiments, intent is identified by a holistic understanding of the sentence, such as analyzing the keywords, a content-context associated with a respective keyword, and relationships among keywords. The holistic meaning and relation to the paragraph and even the document can also influence the intent. The classification is performed based on, at least in part, an intended meaning of the sentences, words, and phrases of the document. Accordingly, in examples, multiple intents are associated with the document. In some embodiments, intents are linked to respective classification levels.

In examples, natural language processing techniques enable an understanding of an intent associated with human language input in the form of text or speech. By analyzing the sequence of words and their probabilities, natural language processing techniques enable a determination of the intent behind a text. For example, certain sequences of words are more likely to indicate specific intents, such as questions, commands, or statements. By examining the probabilities of these sequences, the model can infer the likely intent of the document. Natural language processing techniques include statistical techniques, stochastic techniques, rule-based techniques and hybrid techniques. For example, statistical techniques include N-grams, Hidden Markov Models (HMMs), and Bag-of-Words (BoW). N-grams models a probability of a word based on the previous (n) words. Hidden Markov Models model sequences of words as states with transition probabilities. Bag-of-Words represents text as a collection of word frequencies, ignoring grammar and word order but capturing the overall distribution of words. Additionally, for example, stochastic techniques include probabilistic context-free grammars and Markov Chains. Probabilistic context-free grammars associate probabilities with each production rule, and can be used to parse sentences. Markov Chains determine intent by modeling a probability of transitioning from one state (word or phrase) to another and can be used in text generation and speech recognition.

Rule-based techniques include grammar rules and hybrid techniques. Grammar rules use predefined linguistic rules to parse and understand text. Pattern matching identifies specific patterns in text using regular expressions or other matching techniques. Hybrid techniques combine statistical and rule-based techniques. For example, the natural language processing uses deep-learning models to identify potential parts of speech and then applies grammar rules to refine the analysis. Deep learning models include techniques like transformers that use neural networks to capture complex patterns in text. In examples, combining statistical learning with linguistic insights results in accurate intent determination.

At block 212, previous document intents, keywords, contexts, and classification are extracted from historical data at block 210. The historical data at block 210 includes, for example, documents classified within the organization that can be used as a training data for classification. This includes, for example, business reports, technical reports, memos, emails, etc.

In some embodiments, the information extracted from historical data is used to train at least one machine learning model to compute a classification of a document at block 214. In examples, the model is trained on digital information including text documents, images, tables, engineering drawings, and the like. The machine learning model may be, for example, a supervised or unsupervised machine learning model. In examples, a trained machine learning model is retrained when new data is added to the historical data 210; when the model accuracy degrades below a predetermined threshold; or when feedback is received from a user regarding a quality of document classification output by the trained model (e.g., the user corrects the automatic classification of a document).

The machine learning model may be trained using training data that includes classified and/or annotated historical document data (documents, emails, reports, etc.) and their associated metadata, including metadata associated with the working locations, spaces and zones and their corresponding importance/relevance to information, metadata associated with the working employee roles and their corresponding importance/relevance to information, and historical data records about previous information leakages.

In examples, the trained machine learning model is an ensemble model that combines multiple individual models to improve overall predictive performance. By aggregating the outputs of several models, the ensemble can achieve better accuracy and robustness than any single model alone. In some embodiments, the trained machine learning model is a stacked machine learning model. A stacked machine learning model combines multiple machine learning models to improve predictive performance. In examples, a first level with multiple models are trained on the same dataset. These models can be of different types (e.g., decision trees, neural networks, support vector machines) to leverage their diverse strengths. A second-level model is trained on the predictions of the first level models. This second level-model learns how to best combine the outputs of the base models to make a final prediction. The stacked models can be, for example, a logistic regression model as a second level-model that combines the predictions from first level models including a decision tree, a support vector machine, and a neural network. Stacking combines the strengths of multiple models by training a second level-model on their predictions.

In some embodiments, the trained machine learning model is a cascaded machine learning model. The cascaded machine learning model includes a sequence of models where the output of one model is used as the input for the next. For example, models of the cascade are arranged in a sequence, and each model processes the data and passes its output to the next model in the cascade. Each subsequent model in the cascade can refine or build upon the predictions of the previous models, improving accuracy and handling more complex patterns. For example, determining a context of documents, a cascade of models might include a first model to clean and preprocess the text data; a second model to extract meaningful features from the text; a third model to perform primary classification; a fourth model to refine the initial text classification.

The trained machine learning model is used at block 214 to output a document classification. Inputs to the trained machine learning model include the created, viewed, or modified document, keywords, intents, and context information. The trained machine learning model outputs the document classification.

At block 216, the information document is continuously monitored for any viewings, edits, interactions, or changes in context. In examples, the documents are monitored for changes through an agent, tool, or service that has access to the document, changes made to the document, and the real time contexts associated with the document. The agent will monitor any action performed on the document including viewing or editing.

At block 218, it is determined if any document interaction has occurred. If document interaction has occurred, process flow returns to block 202 for a next iteration of automatic and continuous document analysis. If document interaction has not occurred, process flow continues to block 220 where no changes to the classification occur.

Accordingly, information documents are classified by efficiently, dynamically, and continuously detecting the context of the document by combining conventional keywords/tags with the intentions of the information document detected through natural language understanding. The present techniques capture dynamic and changing contexts associated with the full lifecycle of digital information, including creation, viewing, modifying, and destroying the document, based on the Internet of Things and of the persons interacting with the document (i.e., creators, editors and readers/consumers). The context information includes but is not limited to a temporal context that indicates when a person interacts with the document, a social context that indicates if the interaction occurred in a private space, shared space, with surrounding people, etc., a nature of users who interacted with the information and their roles, and a physical context that indicates the location of the interactions. Further, the present techniques capture dynamic and changing context of virtual surroundings of the document by any application that interacts with the document (e.g., any application's interaction with the document by reading or writing information). Additionally, the present techniques capture users' interactions with the document (e.g., create, read, update, destroy, etc.). In examples, the context information (e.g., temporal, social, nature of users, physical, and virtual), keywords, and intents are used to assign a document classification such as none, business use, public, company general use, confidential, government confidential to the document. The evolution of the document is continuously monitored throughout its full lifecycle and the classification is updated/changed as needed.

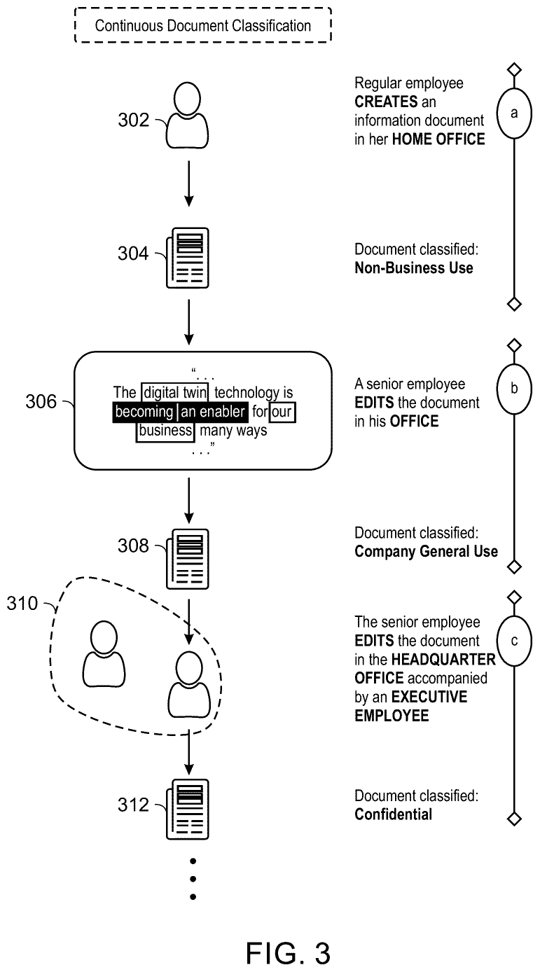

FIG. 3 shows an implementation of automatic, dynamic and continuous information document classification based changing intents and contexts (user proximity to each other and physical location). At reference number 302, a general employee creates an information document in her home office. In examples, a general employee is granted access to documents classified as business use, public, or company general use; a general employee is denied access to documents classified as confidential or government confidential.

At reference number 304, the document is classified as non-business use. In examples, the information document created by the regular employee is evaluated by extracting the document keywords and extracting the document intent. A context of the document is determined by combining conventional keywords and tags with the intents of the information document detected through natural language processing. In examples, context information (e.g., temporal, social, nature of users, physical, and virtual) is determined to assign a document classification to the document. For example, the user is determined, and the environmental context associated with the user is determined. The context of the physical surroundings is based on Internet of Things, persons interacting with the document, temporal aspects, social settings, and the nature of individuals who interact with the document.

At reference number 306, a senior employee edits the document in his office. In examples, a senior employee is granted access to documents classified as business use, public, company general use or confidential; a senior employee is denied access to documents classified as government confidential. The senior employee editing the document triggers and iterative evaluation of the document classification. The context of the document has changed based on the nature of the individual who interacts with the document. In particular, the senior employee is associated with a higher level of classification.

At reference number 308, the document is classified as company general use. The document classification is automatically upgraded to a higher level based on the nature of the senior employee interacting with the document.

At reference number 310, the senior employee edits the document in the headquarters office accompanied by an executive employee. The senior employee editing the document at headquarters triggers another iterative evaluation of the document classification. At reference number 310, the context of the document has changed based on the physical context that includes the location of the individual who interacts with the document. In particular, the headquarters location is associated with a higher level of classification.

At reference number 312, the document is classified as confidential. The document classification is automatically upgraded to a higher level based on the location of the individual interacting with the document. In some embodiments, the assigned classification is the highest classification level applicable in view of the keywords, intents, and respective contexts.

In another example, a senior employee creates a document in his office: In this example, a senior employee creates a new document while working from his office. The document is initiated with low classification (i.e., general use). In some embodiments, when documents are created the documents are classified at a lowest level of confidentiality by default. In some embodiments, when documents are created the documents are classified at a stricter default classification based on the creator role (e.g., for executives always classify the document as medium or high). This policy may be applied based on the role of the creator, or the location of the document creation, etc.

As more general content is added to the document, the document classification remains intact. A change in the classification is triggered when the employee copies a confidential paragraph and figure from another confidential document. This action triggers a classification change to confidential. This classification is later changed to general use as the paragraph was completely rewritten (e.g., became much more high level with no explicit reference to the confidential information) and the figure was removed from the document. In some embodiments, to determine when a paragraph is rewritten for classification purposes, a word count of the paragraph is evaluated to determine if a count of word changes exceeds a threshold, such as 50% of words changed in a paragraph. In some embodiments, to determine when a paragraph is rewritten, keywords are evaluated to determine if the intent of the sentence has changed (e.g., different keywords have different weights that impact the classification), etc.

In another example, a junior employee creates a document in his home office: The document is initiated with low classification such as non-business use as the physical context of the document creation is a private setup and the document itself does not have initially any intent relevant to the company. The junior employee continues to work on the document next day from his company office where the classification of the document automatically increases to company general use due to an added sentence that is associated with an intent relevant to the company business as well as the change in the physical environment (i.e., working from the company office during working hours). Intent reflects a holistic understanding of the sentence or paragraph, which leads to a better understanding of the context of the information mentioned in the document, leading to better classification.

Continuing with the previous example, the junior employee's manager (i.e., senior employee) takes over from the junior employee and continues to edit the document at company headquarters accompanied by a senior executive employee. In this case, the document classification changes automatically to confidential due to the changes in the document surrounding context by being edited at the headquarters and the involvement of the executive.

In another example, a general employee creates and transmits a document classified as government confidential from his home office. The general employee misclassifies the document as government confidential. Prior to sending the document, the system triggers a feedback to the user highlighting the misclassification. In this example, a previous or manual classification of the document is validated as a part of a DLP pipeline that evaluates outgoing communications from a user device. The suggested classification corrections are based on the intent in the document (not governmental despite the appearance of a few keywords related to government matters), and context information including the location of its creation, the receiving parties, as well as the public availability of the information on the governmental web portals. Preventing false alarms due to misclassifications lead to better utilization of the company's DLP process and its allocated resources.

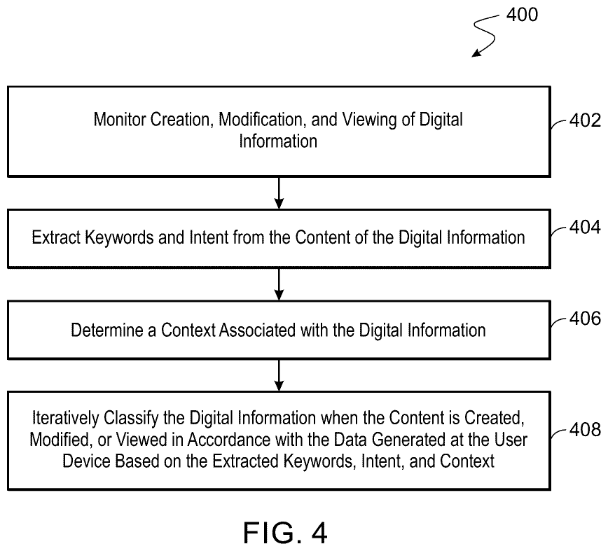

FIG. 4 is a process flow diagram of a process 400 that enables continuous and automated digital information classification.

At block 402, digital information creation, modification, and viewing is monitored. In examples, the content of digital information is modified in accordance with data input at a user device. In examples, digital information is monitored for changes through an agent, tool, or service that has access to the document.

At block 404, keywords and intent are extracted from the content of the digital information. In examples, keywords and intents enable a determination of an origin of data contained in the digital information. For example, keywords and intent are used to determine if content of the digital information has been copied from confidential data, read from a particular device (e.g., a critical device that handles or stores sensitive data), or originated from a closed and confidential meeting. Keywords are, for example, determined using a first trained machine learning model. Intents are extracted using natural language processing techniques.

At block 406, contexts associated with the digital information are determined. Contexts associated with the digital information include contexts associated with the document or file, at least one user, the physical environment, the virtual environment, or any combinations thereof.

At block 408, the digital information is classified based on the keywords, contents' intent and context. When the content of the digital information is created, modified, or viewed in accordance with the data generated at the user device, the digital information is iteratively classified based on the updated extracted keywords and updated contexts associated with the document. Accordingly, the present techniques enable automatically and continuously classify digital information based on the keywords, intent, and contexts of the digital information over the full life cycle of the digital information. The classification of the digital information enables individuals associated with a qualified access level to access the digital information. For example, if digital information is classified as confidential, individuals with access levels that include confidential information can access the digital information. Individuals with access levels that do not include confidential information cannot access the digital information.

In some embodiments, the classification of the digital information governs access to the information. Digital information is classified, and based on the classification specific access controls are implemented. In examples, the classifications are used to restrict access to digital information. For example, higher classification levels dictate increasingly restricted access.

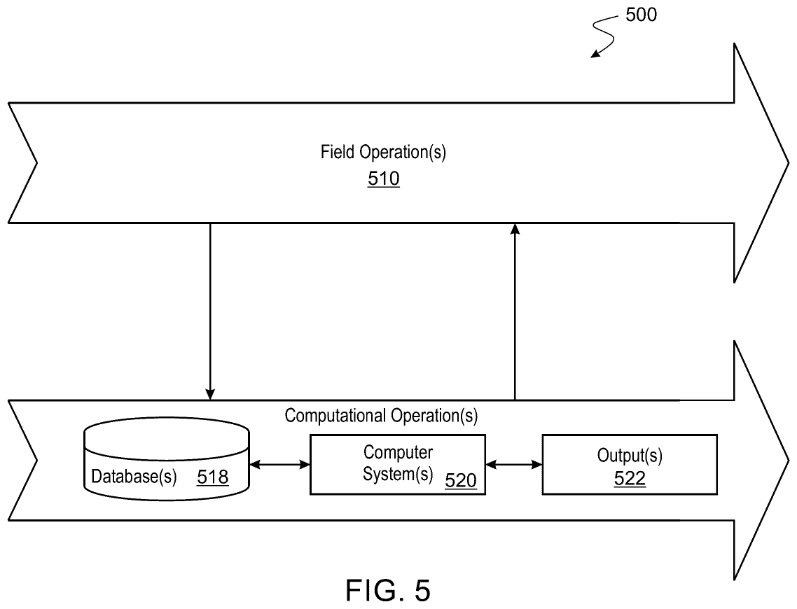

FIG. 5 illustrates hydrocarbon production operations 500 that include both one or more field operations 510 and one or more computational operations 512, which exchange information and control exploration for the production of hydrocarbons. In some implementations, outputs of techniques of the present disclosure can be performed before, during, or in combination with the hydrocarbon production operations 500, specifically, for example, either as field operations 510 or computational operations 512, or both.

Examples of field operations 510 include forming/drilling a wellbore, hydraulic fracturing, producing through the wellbore, injecting fluids (such as water) through the wellbore, to name a few. In some implementations, methods of the present disclosure can trigger or control the field operations 510. For example, the methods of the present disclosure can generate data from hardware/software including sensors and physical data gathering equipment (e.g., seismic sensors, well logging tools, flow meters, and temperature and pressure sensors). The methods of the present disclosure can include transmitting the data from the hardware/software to the field operations 510 and responsively triggering the field operations 510 including, for example, generating plans and signals that provide feedback to and control physical components of the field operations 510. Alternatively or in addition, the field operations 510 can trigger the methods of the present disclosure. For example, implementing physical components (including, for example, hardware, such as sensors) deployed in the field operations 510 can generate plans and signals that can be provided as input or feedback (or both) to the methods of the present disclosure.

Examples of computational operations 512 include one or more computer systems 520 that include one or more processors and computer-readable media (e.g., non-transitory computer-readable media) operatively coupled to the one or more processors to execute computer operations to perform the methods of the present disclosure. The computational operations 512 can be implemented using one or more databases 518, which store data received from the field operations 510 and/or generated internally within the computational operations 512 (e.g., by implementing the methods of the present disclosure) or both. For example, the one or more computer systems 520 process inputs from the field operations 510 to assess conditions in the physical world, the outputs of which are stored in the databases 518. For example, seismic sensors of the field operations 510 can be used to perform a seismic survey to map subterranean features, such as facies and faults. In performing a seismic survey, seismic sources (e.g., seismic vibrators or explosions) generate seismic waves that propagate in the earth and seismic receivers (e.g., geophones) measure reflections generated as the seismic waves interact with boundaries between layers of a subsurface formation. The source and received signals are provided to the computational operations 512 where they are stored in the databases 518 and analyzed by the one or more computer systems 520.

In some implementations, one or more outputs 522 generated by the one or more computer systems 520 can be provided as feedback/input to the field operations 510 (either as direct input or stored in the databases 518). The field operations 510 can use the feedback/input to control physical components used to perform the field operations 510 in the real world.

For example, the computational operations 512 can process the seismic data to generate three-dimensional (3D) maps of the subsurface formation. The computational operations 512 can use these 3D maps to provide plans for locating and drilling exploratory wells. In some operations, the exploratory wells are drilled using logging-while-drilling (LWD) techniques which incorporate logging tools into the drill string. LWD techniques can enable the computational operations 512 to process new information about the formation and control the drilling to adjust to the observed conditions in real-time.

The one or more computer systems 520 can update the 3D maps of the subsurface formation as information from one exploration well is received and the computational operations 512 can adjust the location of the next exploration well based on the updated 3D maps. Similarly, the data received from production operations can be used by the computational operations 512 to control components of the production operations. For example, production well and pipeline data can be analyzed to predict slugging in pipelines leading to a refinery and the computational operations 512 can control machine operated valves upstream of the refinery to reduce the likelihood of plant disruptions that run the risk of taking the plant offline.

In some implementations of the computational operations 512, customized user interfaces can present intermediate or final results of the above-described processes to a user. Information can be presented in one or more textual, tabular, or graphical formats, such as through a dashboard. The information can be presented at one or more on-site locations (such as at an oil well or other facility), on the Internet (such as on a webpage), on a mobile application (or app), or at a central processing facility.

The presented information can include feedback, such as changes in parameters or processing inputs, that the user can select to improve a production environment, such as in the exploration, production, and/or testing of petrochemical processes or facilities. For example, the feedback can include parameters that, when selected by the user, can cause a change to, or an improvement in, drilling parameters (including drill bit speed and direction) or overall production of a gas or oil well. The feedback, when implemented by the user, can improve the speed and accuracy of calculations, streamline processes, improve models, and solve problems related to efficiency, performance, safety, reliability, costs, downtime, and the need for human interaction.

In some implementations, the feedback can be implemented in real-time, such as to provide an immediate or near-immediate change in operations or in a model. The term real-time (or similar terms as understood by one of ordinary skill in the art) means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, considering processing limitations of a described computing system and time required to, for example, gather, accurately measure, analyze, process, store, or transmit the data.

Events can include readings or measurements captured by downhole equipment such as sensors, pumps, bottom hole assemblies, or other equipment. The readings or measurements can be analyzed at the surface, such as by using applications that can include modeling applications and machine learning. The analysis can be used to generate changes to settings of downhole equipment, such as drilling equipment. In some implementations, values of parameters or other variables that are determined can be used automatically (such as through using rules) to implement changes in oil or gas well exploration, production/drilling, or testing. For example, outputs of the present disclosure can be used as inputs to other equipment and/or systems at a facility. This can be especially useful for systems or various pieces of equipment that are located several meters or several miles apart, or are located in different countries or other jurisdictions.

FIG. 6 is a schematic illustration of an example controller 600 (or control system) for that enables continuous and automated digital information classification. For example, the controller 600 may be operable according to the process 400 of FIG. 4. In some embodiments, the controller 600 is the same as or similar to the computer systems 520 of FIG. 5. The controller 600 is intended to include various forms of digital computers, such as printed circuit boards (PCB), processors, digital circuitry, or otherwise parts of a system for supply chain alert management. Additionally, the system can include portable storage media, such as, Universal Serial Bus (USB) flash drives. For example, the USB flash drives may store operating systems and other applications. The USB flash drives can include input/output components, such as a wireless transmitter or USB connector that may be inserted into a USB port of another computing device.

The controller 600 includes a processor 610, a memory 620, a storage device 630, and an input/output interface 640 communicatively coupled with input/output devices 660 (for example, displays, keyboards, measurement devices, sensors, valves, pumps). Each of the components 610, 620, 630, and 640 are interconnected using a system bus 650. The processor 610 is capable of processing instructions for execution within the controller 600. The processor may be designed using any of a number of architectures. For example, the processor 610 may be a CISC (Complex Instruction Set Computers) processor, a RISC (Reduced Instruction Set Computer) processor, or a MISC (Minimal Instruction Set Computer) processor.

In one implementation, the processor 610 is a single-threaded processor. In another implementation, the processor 610 is a multi-threaded processor. The processor 610 is capable of processing instructions stored in the memory 620 or on the storage device 630 to display graphical information for a user interface on the input/output interface 640.

The memory 620 stores information within the controller 600. In one implementation, the memory 620 is a computer-readable medium. In one implementation, the memory 620 is a volatile memory unit. In another implementation, the memory 620 is a nonvolatile memory unit.

The storage device 630 is capable of providing mass storage for the controller 600. In one implementation, the storage device 630 is a computer-readable medium. In various different implementations, the storage device 630 may be a floppy disk device, a hard disk device, an optical disk device, or a tape device.

The input/output interface 640 provides input/output operations for the controller 600. In one implementation, the input/output devices 660 includes a keyboard and/or pointing device. In another implementation, the input/output devices 660 includes a display unit for displaying graphical user interfaces.

There can be any number of controllers 600 associated with, or external to, a computer system containing controller 600, with each controller 600 communicating over a network. Further, the terms “client,” “user,” and other appropriate terminology can be used interchangeably, as appropriate, without departing from the scope of the present disclosure. Moreover, the present disclosure contemplates that many users can use one controller 600 and one user can use multiple controllers 600.

### Embodiments

According to some non-limiting embodiments or examples, provided is a computer-implemented method that enables continuous and automated digital information classification, including: monitoring digital information creation, modification and viewing, where content of digital information is created, modified, or viewed by a user; extracting keywords and intents from the content of the digital information; determining contexts associated with the digital information, where the contexts include a context associated with the user, a context associated with a physical environment, and a context associated with a virtual environment; and iteratively classifying the digital information in response to creation, modification and viewing based on the keywords, intents, and contexts.

According to some non-limiting embodiments or examples, provided is an apparatus including a non-transitory, computer readable, storage medium that stores instructions that, when executed by at least one processor, cause the at least one processor to perform operations including: monitoring digital information creation, modification and viewing, where content of digital information is created, modified, or viewed by a user; extracting keywords and intents from the content of the digital information; determining contexts associated with the digital information, where the contexts include a context associated with the user, a context associated with a physical environment, and a context associated with a virtual environment; and iteratively classifying the digital information in response to creation, modification and viewing based on the keywords, intents, and contexts.

According to some non-limiting embodiments or examples, provided is a system, including: one or more memory modules; one or more hardware processors communicably coupled to the one or more memory modules, the one or more hardware processors configured to execute instructions stored on the one or more memory modules to perform operations including: monitoring digital information creation, modification and viewing, where content of digital information is created, modified, or viewed by a user; extracting keywords and intents from the content of the digital information; determining contexts associated with the digital information, where the contexts include a context associated with the user, a context associated with a physical environment, and a context associated with a virtual environment; and iteratively classifying the digital information in response to creation, modification and viewing based on the keywords, intents, and contexts.

Further non-limiting aspects or embodiments are set forth in the following numbered embodiments:
Embodiment 1: A computer-implemented method that enables continuous and automated digital information classification, including: monitoring digital information creation, modification and viewing, where content of digital information is created, modified, or viewed by a user; extracting keywords and intents from the content of the digital information; determining contexts associated with the digital information, where the contexts include a context associated with the user, a context associated with a physical environment, and a context associated with a virtual environment; and iteratively classifying the digital information in response to creation, modification and viewing based on the keywords, intents, and contexts.
Embodiment 2: The computer implemented method of any preceding embodiment, where the digital information includes text documents, word processing documents, portable document files (PDFs), spreadsheets, presentations, images or videos.
Embodiment 3: The computer implemented method of any preceding embodiment, where a machine learning model trained on historical documents extracts the keywords from the content of the digital information.
Embodiment 4: The computer implemented method of any preceding embodiment, where a trained machine learning model extracts the intents from the content of the digital information.
Embodiment 5: The computer implemented method of any preceding embodiment, where the contexts include a social context that that indicates if a modification to the digital information occurred in a private space, shared space, or with surrounding people.
Embodiment 6: The computer implemented method of any preceding embodiment, where the contexts include a temporal context that indicates a time when the user interacts with the digital information and a duration of the interaction.
Embodiment 7: The computer implemented method of any preceding embodiment, where the contexts include a nature of the user and access levels associated with the user.
Embodiment 8: The computer implemented method of any preceding embodiment, where a classification of the digital information enables individuals associated with a qualified access level to access the digital information.
Embodiment 9: An apparatus including a non-transitory, computer readable, storage medium that stores instructions that, when executed by at least one processor, cause the at least one processor to perform operations including: monitoring digital information creation, modification and viewing, where content of digital information is created, modified, or viewed by a user; extracting keywords and intents from the content of the digital information; determining contexts associated with the digital information, where the contexts include a context associated with the user, a context associated with a physical environment, and a context associated with a virtual environment; and iteratively classifying the digital information in response to creation, modification and viewing based on the keywords, intents, and contexts.
Embodiment 10: The apparatus of any preceding embodiment, where the digital information includes text documents, word processing documents, portable document files (PDFs), spreadsheets, presentations, images or videos.
Embodiment 11: The apparatus of any preceding embodiment, where a machine learning model trained on historical documents extracts the keywords from the content of the digital information.
Embodiment 12: The apparatus of any preceding embodiment, where a trained machine learning model extracts the intents from the content of the digital information.
Embodiment 13: The apparatus of any preceding embodiment, where the contexts include a social context that that indicates if a modification to the digital information occurred in a private space, shared space, or with surrounding people.
Embodiment 14: The apparatus of any preceding embodiment, where the contexts include a temporal context that indicates a time when the user interacts with the digital information and a duration of the interaction.
Embodiment 15: The apparatus of any preceding embodiment, where the contexts include a nature of the user and access levels associated with the user.
Embodiment 16: A system, including: one or more memory modules; one or more hardware processors communicably coupled to the one or more memory modules, the one or more hardware processors configured to execute instructions stored on the one or more memory modules to perform operations including: monitoring digital information creation, modification and viewing, where content of digital information is created, modified, or viewed by a user; extracting keywords and intents from the content of the digital information; determining contexts associated with the digital information, where the contexts include a context associated with the user, a context associated with a physical environment, and a context associated with a virtual environment; and iteratively classifying the digital information in response to creation, modification and viewing based on the keywords, intents, and contexts.
Embodiment 17: The system of any preceding embodiment, where the digital information includes text documents, word processing documents, portable document files (PDFs), spreadsheets, presentations, images or videos.
Embodiment 18: The system of any preceding embodiment, where a machine learning model trained on historical documents extracts the keywords from the content of the digital information.
Embodiment 19: The system of any preceding embodiment, where a trained machine learning model extracts the intents from the content of the digital information.
Embodiment 20: The system of any preceding embodiment, where the contexts include a social context that that indicates if a modification to the digital information occurred in a private space, shared space, or with surrounding people.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs. Each computer program can include one or more modules of computer program instructions encoded on a tangible, non-transitory, computer-readable computer-storage medium for execution by, or to control the operation of, data processing apparatus. Alternatively, or additionally, the program instructions can be encoded in/on an artificially generated propagated signal. The example, the signal can be a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” and “electronic computer device” (or equivalent as understood by one of ordinary skill in the art) refer to data processing hardware. For example, a data processing apparatus can encompass all kinds of apparatus, devices, and machines for processing data, including by way of example, a programmable processor, a computer, or multiple processors or computers. The apparatus can also include special purpose logic circuitry including, for example, a central processing unit (CPU), a field programmable gate array (FPGA), or an application specific integrated circuit (ASIC). In some implementations, the data processing apparatus or special purpose logic circuitry (or a combination of the data processing apparatus or special purpose logic circuitry) can be hardware-or software-based (or a combination of both hardware-and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example, LINUX, UNIX, WINDOWS, MAC OS, ANDROID, or IOS.

A computer program, which can also be referred to or described as a program, software, a software application, a module, a software module, a script, or code, can be written in any form of programming language. Programming languages can include, for example, compiled languages, interpreted languages, declarative languages, or procedural languages. Programs can be deployed in any form, including as stand-alone programs, modules, components, subroutines, or units for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files storing one or more modules, sub programs, or portions of code. A computer program can be deployed for execution on one computer or on multiple computers that are located, for example, at one site or distributed across multiple sites that are interconnected by a communication network. While portions of the programs illustrated in the various figures may be shown as individual modules that implement the various features and functionality through various objects, methods, or processes, the programs can instead include a number of sub-modules, third-party services, components, and libraries. Conversely, the features and functionality of various components can be combined into single components as appropriate. Thresholds used to make computational determinations can be statically, dynamically, or both statically and dynamically determined.

The methods, processes, or logic flows described in this specification can be performed by one or more programmable computers executing one or more computer programs to perform functions by operating on input data and generating output. The methods, processes, or logic flows can also be performed by, and apparatus can also be implemented as, special purpose logic circuitry, for example, a CPU, an FPGA, or an ASIC.

Computers suitable for the execution of a computer program can be based on one or more of general and special purpose microprocessors and other kinds of CPUs. The elements of a computer are a CPU for performing or executing instructions and one or more memory devices for storing instructions and data. Generally, a CPU can receive instructions and data from (and write data to) a memory. A computer can also include, or be operatively coupled to, one or more mass storage devices for storing data. In some implementations, a computer can receive data from, and transfer data to, the mass storage devices including, for example, magnetic, magneto optical disks, or optical disks. Moreover, a computer can be embedded in another device, for example, a mobile telephone, a personal digital assistant (PDA), a mobile audio or video player, a game console, a global positioning system (GPS) receiver, or a portable storage device such as a universal serial bus (USB) flash drive.

Computer readable media (transitory or non-transitory, as appropriate) suitable for storing computer program instructions and data can include all forms of permanent/non-permanent and volatile/non-volatile memory, media, and memory devices. Computer readable media can include, for example, semiconductor memory devices such as random access memory (RAM), read only memory (ROM), phase change memory (PRAM), static random access memory (SRAM), dynamic random access memory (DRAM), erasable programmable read-only memory (EPROM), electrically erasable programmable read-only memory (EEPROM), and flash memory devices. Computer readable media can also include, for example, magnetic devices such as tape, cartridges, cassettes, and internal/removable disks. Computer readable media can also include magneto optical disks and optical memory devices and technologies including, for example, digital video disc (DVD), CD ROM, DVD+/-R, DVD-RAM, DVD-ROM, HD-DVD, and BLURAY. The memory can store various objects or data, including caches, classes, frameworks, applications, modules, backup data, jobs, web pages, web page templates, data structures, database tables, repositories, and dynamic information. Types of objects and data stored in memory can include parameters, variables, algorithms, instructions, rules, constraints, and references. Additionally, the memory can include logs, policies, security or access data, and reporting files. The processor and the memory can be supplemented by, or incorporated in, special purpose logic circuitry.

Implementations of the subject matter described in the present disclosure can be implemented on a computer having a display device for providing interaction with a user, including displaying information to (and receiving input from) the user. Types of display devices can include, for example, a cathode ray tube (CRT), a liquid crystal display (LCD), a light-emitting diode (LED), and a plasma monitor. Display devices can include a keyboard and pointing devices including, for example, a mouse, a trackball, or a trackpad. User input can also be provided to the computer through the use of a touchscreen, such as a tablet computer surface with pressure sensitivity or a multi-touch screen using capacitive or electric sensing. Other kinds of devices can be used to provide for interaction with a user, including to receive user feedback including, for example, sensory feedback including visual feedback, auditory feedback, or tactile feedback. Input from the user can be received in the form of acoustic, speech, or tactile input. In addition, a computer can interact with a user by sending documents to, and receiving documents from, a device that is used by the user. For example, the computer can send web pages to a web browser on a user's client device in response to requests received from the web browser.

The computing system can include clients and servers. A client and server can generally be remote from each other and can typically interact through a communication network. The relationship of client and server can arise by virtue of computer programs running on the respective computers and having a client-server relationship. Cluster file systems can be any file system type accessible from multiple servers for read and update. Locking or consistency tracking may not be necessary since the locking of exchange file system can be done at application layer. Furthermore, Unicode data files can be different from non-Unicode data files.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any suitable sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Other embodiments are within the scope of the following claims. For example, the actions recited in the claims can be performed in a different order and still achieve desirable results. As one example, some processes depicted in the accompanying figures do not necessarily require the particular order shown, or sequential order, to achieve desirable results.

1. A computer-implemented method that enables continuous and automated digital information classification, comprising:
monitoring, by an agent executing on a user device or server, creation, opening, editing. viewing, or saving events associated with digital information;
extracting keywords and intents from the content of the digital information;
determining contexts associated with the digital information, wherein the contexts comprise (i) temporal context comprising time and duration of interaction; (ii) social context determined via local proximity sensing using Internet-of-Things devices and/or a centralized localization service to identify surrounding users and whether the interaction occurs in a private or shared space; (iii) physical context comprising a geographic location of the user; and (iv) user-nature context comprising the user's role and access level;
iteratively classifying the digital information in response to the events based on the keywords, intents, and contexts, the class comprising at least business use, company general use, confidential, and government confidential.

2. The computer implemented method of claim 1, wherein the digital information comprises text documents, word processing documents, portable document files (PDFs), spreadsheets, presentations, images or videos.

3. The computer implemented method of claim 1, wherein a machine learning model trained on historical documents extracts the keywords from the content of the digital information.

4. The computer implemented method of claim 1, wherein a trained machine learning model extracts the intents from the content of the digital information.

5. The computer implemented method of claim 1, wherein the contexts comprise a social context that that indicates if a modification to the digital information occurred in a private space, shared space, or with surrounding people.

6. The computer implemented method of claim 1, wherein the contexts comprise a temporal context that indicates a time when the user interacts with the digital information and a duration of the interaction.

7. The computer implemented method of claim 1, wherein the contexts comprise a nature of the user and access levels associated with the user.

8. The computer implemented method of claim 1, wherein a classification of the digital information enables individuals associated with a qualified access level to access the digital information.

9. An apparatus comprising a non-transitory, computer readable, storage medium that stores instructions that, when executed by at least one processor, cause the at least one processor to perform operations comprising:
monitoring, by an agent executing on a user device or server, creation, opening, editing. viewing, or saving events associated with digital information;
extracting keywords and intents from the content of the digital information;
determining contexts associated with the digital information, wherein the contexts comprise (i) temporal context comprising time and duration of interaction; (ii) social context determined via local proximity sensing using Internet-of-Things devices and/or a centralized localization service to identify surrounding users and whether the interaction occurs in a private or shared space; (iii) physical context comprising a geographic location of the user; and (iv) user-nature context comprising the user's role and access level; and
iteratively classifying the digital information in response to the events based on the keywords, intents, and contexts, the class comprising at least business use, company general use, confidential, and government confidential.

10. The apparatus of claim 9, wherein the digital information comprises text documents, word processing documents, portable document files (PDFs), spreadsheets, presentations, images or videos.

11. The apparatus of claim 9, wherein a machine learning model trained on historical documents extracts the keywords from the content of the digital information.

12. The apparatus of claim 9, wherein a trained machine learning model extracts the intents from the content of the digital information.

13. The apparatus of claim 9, wherein the contexts comprise a social context that that indicates if a modification to the digital information occurred in a private space, shared space, or with surrounding people.

14. The apparatus of claim 9, wherein the contexts comprise a temporal context that indicates a time when the user interacts with the digital information and a duration of the interaction.

15. The apparatus of claim 9, wherein the contexts comprise a nature of the user and access levels associated with the user.

16. A system, comprising:
one or more memory modules;
one or more hardware processors communicably coupled to the one or more memory modules, the one or more hardware processors configured to execute instructions stored on the one or more memory modules to perform operations comprising:
monitoring, by an agent executing on a user device or server, creation, opening, editing, viewing, or saving events associated with digital information;
extracting keywords and intents from the content of the digital information;
determining contexts associated with the digital information, wherein the contexts comprise (i) temporal context comprising time and duration of interaction; (ii) social context determined via local proximity sensing using Internet-of-Things devices and/or a centralized localization service to identify surrounding users and whether the interaction occurs in a private or shared space; (iii) physical context comprising a geographic location of the user; and (iv) user-nature context comprising the user's role and access level; and
iteratively classifying the digital information in response to the events based on the keywords, intents, and contexts, the class comprising at least business use, company general use, confidential, and government confidential.

17. The system of claim 16, wherein the digital information comprises text documents, word processing documents, portable document files (PDFs), spreadsheets, presentations, images or videos.

18. The system of claim 16, wherein a machine learning model trained on historical documents extracts the keywords from the content of the digital information.

19. The system of claim 16, wherein a trained machine learning model extracts the intents from the content of the digital information.

20. The system of claim 16, wherein the contexts comprise a social context that that indicates if a modification to the digital information occurred in a private space, shared space, or with surrounding people.
